(19) United States
(12) Patent Application Publication
(10) Pub. No.: US 2024/0134186 A1
(43) Pub. Date: Apr. 25, 2024

(54) HARSH ENVIRONMENT SENSOR ENCLOSURE AND CLEANING SYSTEM

(71) Applicant: Stanadyne Operating Company LLC, Jacksonville, NC (US)

(72) Inventors: Michael Hornby, Emerald Isle, NC (US); Stephen Bugos, Summerville, SC (US)

(21) Appl. No.: 18/493,271

(22) Filed: Oct. 23, 2023

Related U.S. Application Data
(60) Provisional application No. 63/419,055, filed on Oct. 25, 2022.
(60) Provisional application No. 63/448,445, filed on Feb. 27, 2023.

(51) Int. Cl. G02B 27/00; B60S 1/56; F16K 31/06; H04N 23/51

(52) U.S. Cl. CPC G02B 27/0006; B60S 1/56; F16K 31/0665; H04N 23/51; G01S 2007/4977

(57) ABSTRACT

A harsh environment sensor housing and cleaning system includes sensor enclosures with a rotationally symmetrical lens that can be cleaned in a lens washing space defined by the sensor enclosure. Each sensor enclosure includes a motor coupled to the lens to rotate the lens within the sensor enclosure, allowing a dirty portion of the lens move through the lens washing space for cleaning, and a clean portion of the lens to be placed in front of a sensor or camera within the sensor enclosure. A sensor enclosure and cleaning system incorporates a control unit, fluid control valves, a manifold, and fluid conduits to deliver wash fluid to each sensor housing. The fluid control valves have a reduced part count and can be used to control flow of liquids or gasses such as air.

### BACKGROUND

The present disclosure relates to a system for protecting and cleaning cameras and sensors on motorized vehicles working in harsh environments.

Modern vehicles include an increasing number of cameras and sensors that provide critical information to vehicle operators and vehicle systems. Operator information may include real time images of areas surrounding the vehicle that are not visible to the operator such as a region behind the vehicle. Operator information may also include signals regarding obstacles, or other vehicles within or approaching one or more blind spots around the vehicle. Vehicle system information may be provided by sensors arranged to detect obstacles, lane markings, pedestrians or other vehicles that allow vehicle systems to perform functions such as autonomous navigation, lane keeping, speed control, and emergency braking. Sensors include LIDAR and other types of obstacle and movement detection sensors. Cameras may be arranged to provide images behind the vehicle and in vehicle blind spots.

Vehicles are exposed to widely variant environmental conditions that include snow and ice, dust, mud, road salt residue, and insects that form deposits on external optical surfaces of the camera or sensor and reduce or prevent the camera or sensor from performing its intended function. Vehicles operate in a wide variety of environments and the disclosed sensor system is applicable to agricultural equipment, off road construction equipment, over the road trucking and towing equipment, mass transit vehicles such as busses, and passenger cars, sport utility vehicles, campers and the like. Many of these vehicles operate in harsh environments at least part of the time, where the harsh environment can form deposits on the outermost surfaces of cameras and sensors that must be removed for the camera or sensor to function properly. In some cases, inoperative cameras or sensors can prevent the vehicle from operation and lead to vehicle downtime until the cameras or sensors are cleaned. In some cases the camera or sensor is placed in a location that may be inaccessible or inconvenient for operators or service personnel to reach or access.

Known camera and sensor cleaning systems are extensions of prior art window cleaning systems and use window wash liquid sprayed onto the external surfaces of the camera or sensor to remove deposits. There are several drawbacks to the prior art systems. The systems tend to lack any physical wiping or other contact with the surface being cleaned, which makes prior art systems less effective at removing films or dried deposits such as bug residue or dried mud. The prior art systems do not recover the cleaning fluid. In cold environments, window cleaning fluid necessarily contains significant proportions of alcohol such as ethanol and/or methanol, which is a hydrocarbon that can contribute to air pollution and global warming when released into the environment. Failure to recover washing fluid can also lead to vehicle down time if fluid reserves are exhausted and cleaning systems are rendered inoperative for this reason.

There is a need for camera and sensor cleaning systems for use on vehicles of all types where the cleaning system is effective at removing deposits that form on cameras and sensors.

There is a need for camera and sensor cleaning systems for use on vehicles where the cleaning system recovers cleaning fluid to prevent uncontrolled release into the environment.

### SUMMARY OF THE INVENTION

A harsh environment sensor housing and cleaning system includes sensor enclosures with a rotationally symmetrical lens that can be cleaned in a lens washing space defined by the sensor enclosure. Washing fluid is recovered from each lens washing space for re-use or appropriate disposal. Each sensor enclosure includes a motor coupled to the lens to rotate the lens within the sensor enclosure, allowing a dirty portion of the lens move through the lens washing space for cleaning, and a clean portion of the lens to be placed in front of a sensor or camera within the sensor enclosure. Wipers and seals separate the lens washing space from the surrounding environment and from a sensor chamber where the camera or sensor is mounted. Each sensor enclosure includes an outlet allowing used washing fluid to drain from the lens washing space for collection. The rotationally symmetrical lens may be selected from a group including a cylinder, a flat circle, a hemisphere, a portion of a sphere, and a convex dome.

The cleaning system includes a source of washing fluid, a distribution manifold and fluid conduits connecting the source of washing fluid to the distribution manifold and the distribution manifold to the sensor enclosures. The distribution manifold supports a plurality of solenoid operated fluid control valves that control delivery of washing fluid to each of the sensor enclosures. The cleaning system may collect used washing fluid for appropriate disposal, or may include a filter with pump to filter used washing fluid and return the filtered washing fluid to a reservoir for reuse.

A control unit is connected to vehicle systems that utilize information from the cameras or sensors contained in the sensor housings. The vehicle systems alert the control unit that one or more of the lenses need to be cleaned, and the control unit operates a washing fluid pump and actuates a solenoid valve in the distribution manifold to send washing fluid to the lens washing space. The control unit also applies power to a motor in the sensor enclosure to rotate the lens, moving the dirty portion of the lens through the lens washing space where washing fluid and wipers remove material from the outside surface of the lens. Rotation of the lens allows a clean portion of the lens to be positioned in front of the camera or sensor.

A simplified, high-flow solenoid actuated fluid control valve is disclosed. The inlet of the solenoid operated valve functions as the pole of the solenoid and includes an integral inlet coupling. The outlet of the solenoid operated valve defines a valve seat and includes an integral outlet coupling. A non-magnetic tubular body connects the inlet to the outlet and surrounds an axial gap between an armature and a second end of the inlet. The non-magnetic tubular body directs magnetic flux generated by the solenoid coil through the armature and pole, while serving to contain fluid within the valve and support the inlet and outlet in axial positions that define the opening distance of a valve member connected to the armature. The fluid control valves may include a non-metallic shock absorbing element between the armature and the pole to prevent direct contact between the armature and pole to reduce sound emitted when the valve is operated.

Distribution manifolds receive the solenoid actuated fluid control valves and the control unit actuates the valves as needed to distribute washing fluid to the sensor housings as needed.

### BRIEF DESCRIPTION OF THE DRAWINGS

FIG. 1 illustrates a representative sensor cleaning system according to aspects of the disclosure;

FIG. 2 is a front elevation view of a sensor housing incorporating a cleaning system according to aspects of the disclosure;

FIG. 3 is a vertical sectional view through the sensor housing and cleaning system shown in FIG. 2, taken along line 3-3 thereof;

FIG. 4 is a horizontal sectional view through the sensor housing and cleaning system shown in FIG. 2, taken along line 4-4 thereof;

FIG. 5 is a perspective view of a first embodiment of a solenoid operated high flow valve according to aspects of the disclosure;

FIG. 6 is a vertical sectional view of the solenoid operated high flow valve of FIG. 5;

FIG. 7 is a vertical sectional view through a second embodiment of a solenoid operated high flow valve according to aspects of the disclosure;

FIG. 8 is a top perspective view of a first embodiment of a fluid distribution manifold incorporating three solenoid operated high flow valves according to aspects of the disclosure;

FIG. 9 is a horizontal sectional view through the fluid distribution manifold of FIG. 8, with the solenoid operated high flow valves shown in perspective;

FIG. 10 is a horizontal sectional view through an alternative fluid distribution manifold incorporating three solenoid operated high flow valves of FIG. 7;

FIGS. 11 and 12 are schematic illustrations of an alternative sensor enclosure according to aspects of the disclosure;

FIG. 13 is a schematic illustration of an alternative sensor cleaning system employing compressed air according to aspects of the disclosure; and

FIGS. 14 and 15 are side and top views, respectively, of a third embodiment of a sensor enclosure according to aspects of the disclosure.

### DETAILED DESCRIPTION

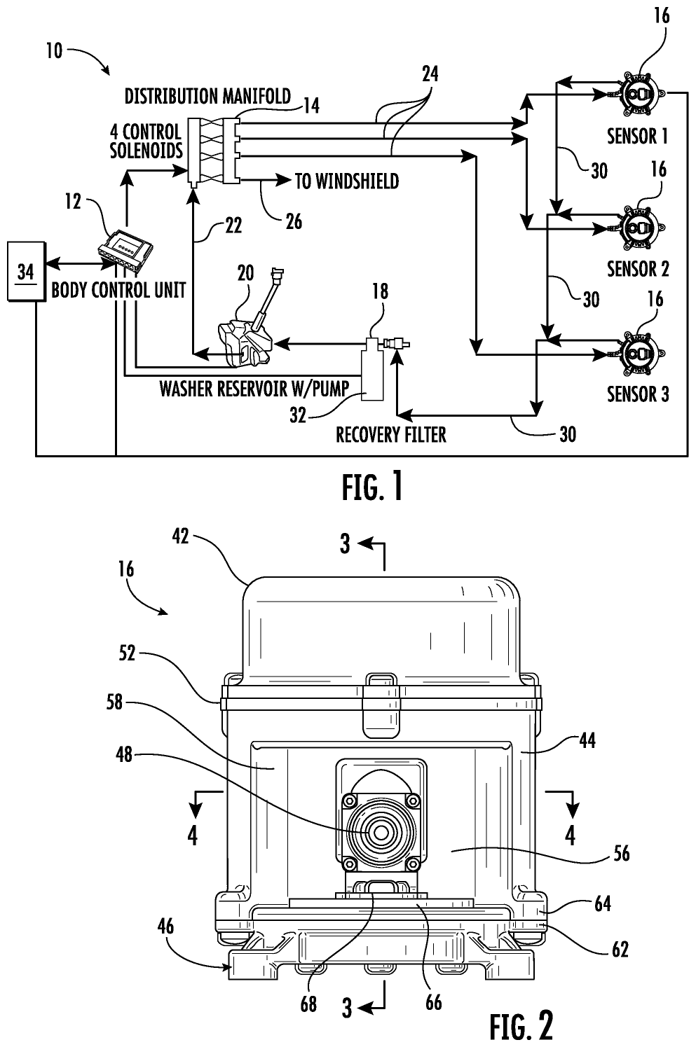

FIG. 1 illustrates a representative embodiment of a harsh environment sensor cleaning system 10 according to aspects of the disclosure. The system 10 includes a control unit 12, a fluid distribution manifold 14, a plurality of sensor enclosures 16, a fluid recovery filter 18 and a fluid reservoir with pump 20. A fluid conduit 22 is shown connecting the fluid reservoir 20 to a distribution manifold 14. Fluid conduits 24 extend from the distribution manifold 14 to each of the sensor enclosures 16. A separate fluid conduit 26 connects the distribution manifold 14 to one or more windshield washing nozzles (not shown). Fluid return conduits 30 are connected to an outlet of each sensor enclosure 16 to return used fluid to the recovery filter 18 where particulates are removed from the fluid before the used fluid is returned to the reservoir 20. The recovery filter 18 may include a replaceable filter element 32 and a pump to draw used wash fluid from the return conduits 30. The used wash fluid may be filtered and re-used or accumulated in a separate reservoir (not shown) for later filtration or appropriate disposal. The control unit 12, manifold 14, reservoir/pump 20 and recovery filter 18 may be located in an engine compartment or other convenient location on the vehicle. The sensor enclosures 16 are located at various positions on the associated vehicle as dictated by the type and function of the camera or sensor within the enclosure 16.

The control unit 12 is electrically connected to the distribution manifold 14, each of the sensor enclosures 16, the fluid reservoir/pump 20 and to vehicle power and other vehicle control and communication systems 34. The control unit 12 includes a processor and memory or a microcontroller with inputs for communications and signals as well as outputs to deliver vehicle power to the the pump 20, valves in the distribution manifold 14 and motors 50 in each sensor enclosure 16. The control unit 12 may also provide power to a pump to draw used wash fluid out of the return conduits 30. Delivery of wash fluid to the enclosures 16 will require application of power to the pump 20 and opening of one or more of the valves in the distribution manifold 14. The control unit 12 is also electrically connected to each enclosure 16 to provide power to a motor 50 within each enclosure as will be described in greater detail below. Vehicle systems 34 may monitor the quality of sensor and/or image data returned from sensors and cameras distributed on the vehicle and provide a signal to the control unit 12 to clean one or more of the sensors. Alternatively, sensor cleaning could be performed on a schedule. The structure and function of a control unit 12 is well-understood by those skilled in the art and will not be discussed in detail in this application.

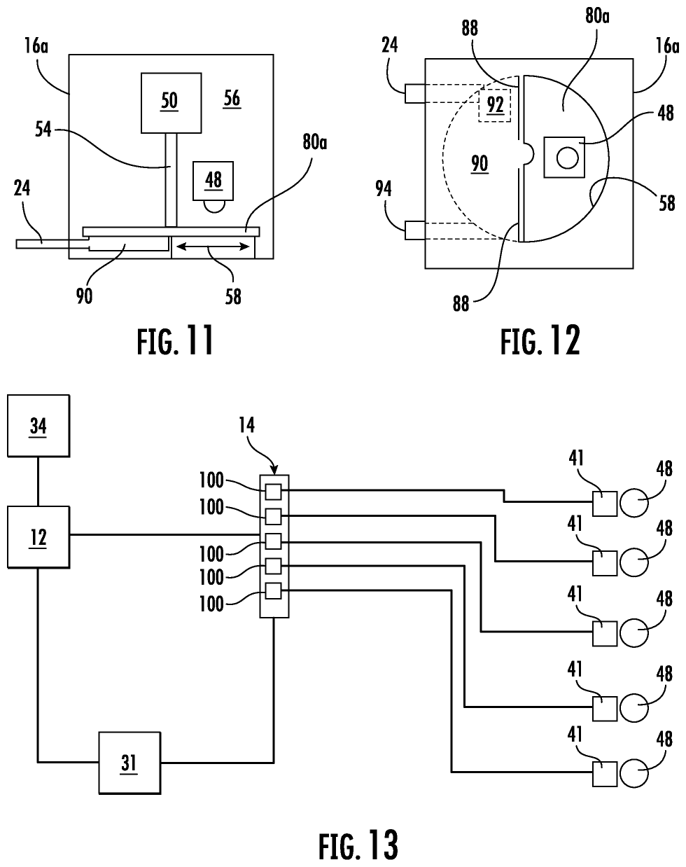

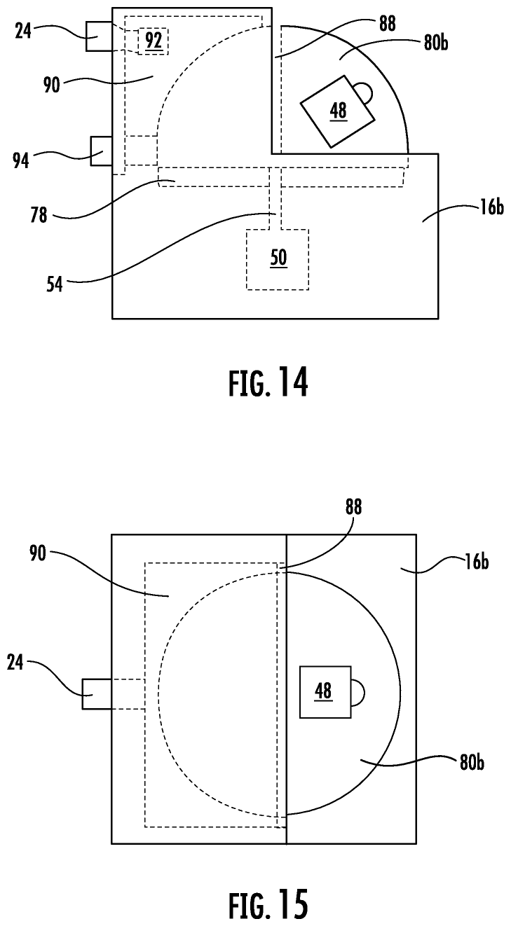

FIGS. 2-4 illustrate a first embodiment of a sensor enclosure 16 according to aspects of the disclosure. Although a specific configuration is disclosed with respect to the senor enclosures 16, the invention is not limited to the disclosed enclosure configurations. The sensor enclosure 16 includes a cover 42, a body 44 and a base 46. Together, the cover 42, body 44 and base 46 define an enclosure 16 surrounding a camera or sensor 48. The cover 42 defines a space for a motor 50 that may include gear reduction. A motor mounting plate 52 is arranged between the cover 42 and the body 44 and supports the motor 50 within the cover 42. The mounting plate 52 includes an opening for a shaft 54 of the motor 50 to extend toward a sensor chamber 56 defined within the body 44. The body 44 defines a sensor opening 58 spanning at least 90° of a circumference of the sensor enclosure 16. The sensor opening 58 allows the sensor or camera 48 to receive information (such as light) from the environment and/or transmit a signal (such as a laser or infrared light) and receive signals returned from the environment. The size and angular extent of the sensor opening 58 can be configured for the structure and function of the camera or sensor 48 installed in the enclosure 16. For example, the sensor opening 58 may span 180° or more of a circumference of the enclosure 16. Alternatively, the sensor opening may be planar and closed by a flat lens 80a as shown in FIGS. 11 and 12 or a dome shaped lens 80b as shown in FIGS. 14 and 15. The lenses 80, 80a, 80b are rotationally symmetrical and span the sensor opening 58.

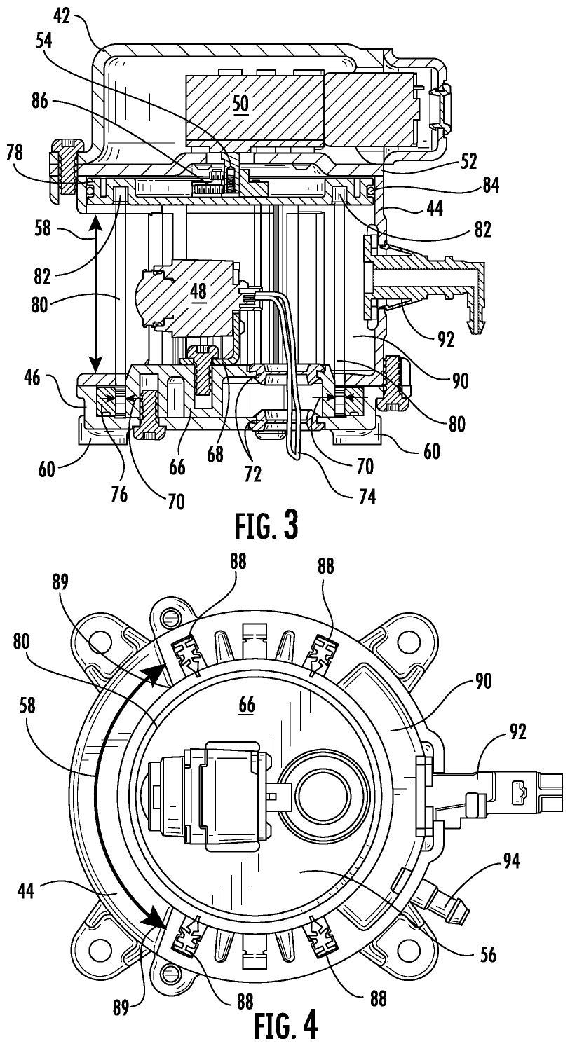

The base 46 includes bosses 60 for fasteners that mount the base to a vehicle surface (not shown). The base 46 also includes a peripheral upstanding rim with radially projecting bosses 62 that mate cooperating bosses 64 with a corresponding lower end of the body 44. Fasteners extend through bosses 62 and 64 to join the base to the body 44. This method of securing the parts of the enclosure 16 to each other is one example and other methods such as spin welding or adhesives may also be used. A pedestal 66 occupies a central region of the base 46 and projects upwardly to support a sensor bracket 68 that mounts the camera or sensor 48. An annular seal 76 is positioned within the upstanding lip of the base 46 and defines a gap 70 between the outside circumference of the pedestal 66 and an inside circumference of the seal 76 as shown in FIG. 3. The pedestal 66 and base 46 define openings sealed by grommets 72. The openings and grommets 72 provide a sealed path for conductors 74 from the sensor 48 to connect with vehicle power, automation and guidance systems as shown in FIG. 3.

A lens mounting plate 78 spans an upper end of the body 44 below the motor mounting plate 52. The function of the lens mounting plate 78 is to support and rotate a cylindrical lens 80 that extends downwardly from the lens mounting plate 78 on the inside of the body 44 and into the gap 70 defined between the pedestal 66 and seal 76. The lens mounting plate 78 defines a downward facing annular groove 82 that receives an upper end of the cylindrical lens 80, which is secured in the annular groove 82 by adhesive or other known method. A radial periphery of the lens mounting plate 78 defines a gland for a seal 84 against an inside surface of the upper end of the body 44. The cylindrical lens 80 may be constructed of Pyrex, or other clear, durable material such as glass or very hard coated plastic. The cylindrical lens 80 spans the sensor opening 58 and protects the sensor chamber 56 from intrusion of environmental moisture and contaminants, so the sensor 48 is protected from the environment while still having a clear and unobstructed field of view through the sensor opening 58. In the disclosed embodiment, the lens mounting plate 78 is coupled to the motor shaft 54 by a hub 86 and fasteners, but any method of attachment that ensures a reliable coupling between the motor shaft 54 and lens mounting plate 78 is compatible with the disclosed sensor enclosure 16.

As best shown in FIG. 4, the disclosed sensor enclosure 16 includes wipers 88 that contact an outside surface of the cylindrical lens 80. In the disclosed embodiment, there are 4 wipers 88, with two wipers 88 arranged on one side if the lens 80 and two wipers 8 on an opposite side of the lens 80. The wipers 88 extend vertically in the body 44 from the bottom of the lens mounting plate 78 to a top surface of the seal 76 so that a wiping edge of the wipers 88 is in contact with an outside surface of the lens 80. The wipers 88 may be constructed of any known material that will be durable and function to remove debris from the surface of the lens 80. The number and configuration of the wipers 88 is not limited to the wiper configuration shown, and the wipers 88 may be of the same construction or different construction as needed to perform the desired function. For example, the wipers 88 may take the form of a stiff brush or similar device to aid in removing dried material from an outside surface of the lens 80. On a side of the sensor enclosure 16 opposite the sensor opening 58 and between the two groups of wipers 88, the sensor enclosure 16 defines a lens washing space 90. The wipers 88 also function to contain washing fluid within the lens washing space 90 at the vertical sides of the washing space 90, while the seal 84 and seal 76 contain washing fluid in the lens washing space 90 at the top and bottom of the lens washing space 90, respectively. Vertical edges 89 of the body 44 defining the vertical sides of the sensor opening 58 are arranged close to the outside surface of the lens 80 and provide a scraping action to remove debris that may accumulate on the outside surface of the lens.

A washing fluid spray nozzle 92 is arranged to spray washing fluid onto the surface of the lens 80 within the lens washing space 90. The spray nozzle 92 may have any configuration selected to preferably spray washing fluid onto the outside surface of the lens 80 over the entire surface (vertical and horizontal) of the lens 80 within the lens washing space 90. The nozzle 92 may have more than one spray orifice to distribute washing fluid over the surface of the lens 80. The nozzle 92 or nozzles may be selected to spray washing fluid onto the lens 80 with sufficient force to assist in removing material from the lens 80. The wipers 88 will also act to physically remove material and washing fluid from the surface of the lens 80. The sensor enclosure 16 defines a wash fluid outlet 94 to allow used wash fluid to flow out of the lens washing space 90. A pressure increase in the lens washing space 90 when wash fluid is being released may help facilitate flow of used wash fluid out of the lens washing space 90, along with gravity and a negative pressure in a drain conduit 30 generated by a pump which may be associated with the recovery filter 18. In one embodiment of a system 10 illustrated in FIG. 1, used wash fluid flows from the outlet 94 through a return conduit 30 to the recovery filter 18 where a pump pushes the used wash fluid through a filter and circulates the filtered wash fluid back to the washer reservoir 20. In alternative embodiments, the used wash fluid is collected for later recycling or disposal in an environmentally friendly manner. One objective of the disclosed system is to collect most of the washing fluid for re-use or responsible disposal, in contrast to the uncontrolled release that is common in the prior art.

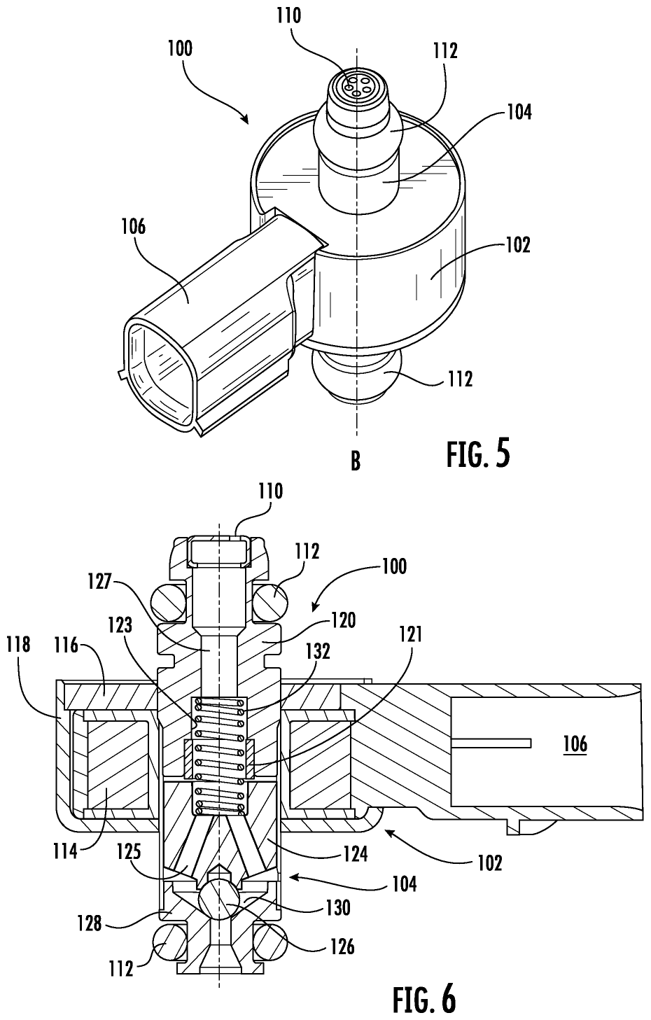

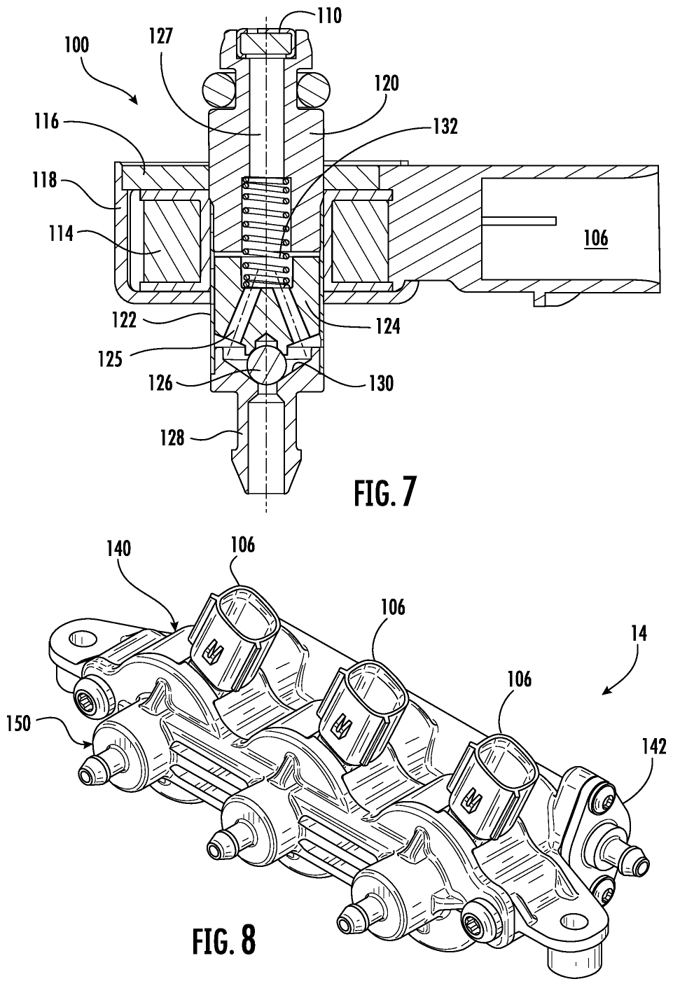

Another aspect of the disclosure relates to simple, low cost, high flow valves that can be used in one or more distribution manifolds 14 to distribute wash fluid to the sensor enclosures 16 and existing window washing nozzles on a vehicle. FIGS. 5-7 illustrate embodiments of a solenoid actuated fluid control valve 100 having a reduced part count and providing a high rate of flow. A first embodiment of a fluid control valve 100 is illustrated in FIGS. 5 and 6. The fluid control valve 100 may be used with a liquid such as automotive window wash solution or a gas such as compressed air at operating pressures up to 20 bar. The fluid contact components of the valve 100 are stainless-steel selected to be compatible with washer fluids and moisture. The valve 100 may be configured with a barbed outlet shown in FIG. 7 or an o-ring outlet fluid connector as shown in FIGS. 5 and 6. The electrical components are modular and allow fast and efficient changeover between various electrical connector configurations. As shown in FIGS. 5 and 6, an embodiment of a reduced noise fluid control valve 100 includes a coil assembly 102 surrounding a valve body 104. An electrical connector 106 connects the valve 100 to a control unit (such as control unit 12 shown in FIG. 1) so that power applied to the coil assembly 102 generates a magnetic field that acts on an armature 124 of the valve to open the valve and allow flow of fluid to the outlet 128. An inlet end of the valve 100 may include a particle screen or filter 110 to prevent circulation of particles that may be present in the fluid. The inlet and outlet ends of the valve 100 may include a seal 112 in a gland to seal the valve 100 against complementary structures of a manifold 14 or other distribution device.

The coil assembly 102 includes a coil 114 wound on a bobbin and connected to the electrical connector 106 to receive power to open the valve. A flux washer 116 and housing 118 form part of a path for magnetic flux generated by the coil 114. The valve 100 includes an inlet 120 that also serves as a pole of the solenoid. The inlet 120 receives the filter 110, defines a gland for seal 112 and functions as a primary component of the body 104 of the valve 100. The inlet 120 is constructed of magnetic steel and serves as a pole for the solenoid. A non-magnetic metal tube 122 is welded to a lower end of the inlet 120 and surrounds the armature 124. The metal tube 122 may for example be non-magnetic stainless steel. A valve member 126 is welded to one end of the armature 124. The armature 124 defines fluid flow passages 125 communicating with a central passage 127 of the inlet 120. The valve body 104 includes an outlet 128 welded to the non-magnetic metal tube 122. The outlet 128 defines a valve seat 130 and supports an outlet seal 112. A valve return spring 132 biases the armature 124 away from the inlet 120 (pole) into a closed position with the valve member 126 against the valve seat 130. The flux washer 116 may be welded to the inlet 120 and to the solenoid housing 118 to secure the solenoid assembly 102 to the valve body 104. Power applied to the coil 114 generates magnetic flux that attracts the armature 124 toward the pole/inlet 120, compresses the return spring 132 and moves the valve member 126 away from the valve seat 130 to allow fluid to flow from the inlet central passage 127, through the armature fluid flow passages 125 and out the outlet 128 of the valve 100. Using a non-magnetic metal tube 122 forces magnetic flux through the armature 124 and enhances the response time of the valve 100, while potentially reducing power consumption. The non-magnetic tube 122 also forms a structural member of the valve body 104, connecting the inlet 120 to the outlet 128. The disclosed valve configuration reduces part count and provides a reliable, low-cost solenoid actuated valve 100.

According to aspects of the disclosure, the inlet 120 includes a stepped axial bore 123 that defines a shoulder against which the return spring 132 is biased. The stepped bore 123 includes a second shoulder supporting a shock absorbing element 121 that projects beyond the end face of the pole/inlet 120. The armature 124 reciprocates between the closed position illustrated in FIG. 6 and an open position where the armature 124 is attracted to the pole/inlet 120 when power is applied to the coil 114. The disclosed shock absorbing element 121 is a cylinder with an end projecting beyond the end face of the pole/inlet a distance of at least 0.5 mm. The end of the shock absorbing element may be a continuous, flat annular surface or may be shaped or interrupted to further reduce the area of surface contact between the armature and the shock absorbing element 121. When the armature 124 is attracted toward the pole/inlet 120, the armature 124 contacts the shock absorbing element 121 and is prevented from directly contacting the pole/inlet 120. This significantly reduces the noise generated by actuation of the valve 100. Testing shows that without the shock absorbing element 121, the valve in a manifold generated a peak sound level of 63 DB. An embodiment of the fluid control valve 100 with the shock absorbing element 121 installed in a manifold generated a peak sound level of 53 DB. Since the decibel scale is logarithmic, this 10 DB reduction means that the sound energy emitted from the valve 100 including the shock absorbing element 121 is reduced by a factor of approximately 10 relative to a valve such as the valve illustrated in FIG. 7 that lacks the shock absorbing element.

The shock absorbing element 121 illustrated in FIG. 1 is an exemplary embodiment of a shock absorbing element and the disclosure is not limited to this configuration or location for a shock absorbing element 121. The shock absorbing element may alternatively be made part of the armature 124 and may take the form of a cylindrical body of shock absorbing material such as PEEK plastic surrounding the return spring 132. Alternative, durable shock absorbing materials may be used. In this arrangement, the shock absorbing element would project axially beyond the top face of the armature 124 to contact the end face of the pole 120 when the valve 100 is moved to the open position. Whether the shock absorbing element 121 is supported by the pole 120 or the armature 124, the configuration of the shock absorbing element is not limited to a cylinder and the location of the shock absorbing element is not limited to a central location surrounding the return spring 132. The shock absorbing element 121 may be located in any position on either the pole 120 or the armature 124 that serves the function of absorbing impact between the armature 124 and the pole 120 when the valve 100 is opened. This function of the shock absorbing element 121 requires some portion of the shock absorbing element 121 to be positioned between the pole 121 and the armature 124 and prevent direct contact between the pole 120 and the armature 124 when the valve 100 is opened.

FIG. 7 illustrates a second embodiment of a fluid control valve 100 according to aspects of the disclosure. The control valve 100 of FIG. 7 differs from the control valve of FIGS. 5 and 6 by omitting the shock absorbing element 121 and incorporating a barbed outlet connector 128. In all other respects, the control valve of FIG. 7 is structurally and functionally identical to the control valve of FIGS. 5 and 6.

The disclosed valve 100 integrates the structure of an inlet and seal 112 with the magnetic pole of the solenoid to reduce part count. The configuration of the inlet 120 and seal 112 can be selected to be compatible with the structure of a distribution manifold 114 or other fluid connections. As shown in FIGS. 5 and 6, the outlet 128 may be configured to define a seal gland and seal 112 that is similar to the seal gland and seal 112 defined by the inlet 120. Alternatively, the outlet 128 may be configured with a barbed connection as shown in FIG. 7 or any other selected outlet coupling. The modular valve configuration allows exchange of outlet couplings by selection of a different outlet component 128. The coil assembly 102 includes an electrical connector 106 that can be selected to be compatible with alternative connection systems. Different coil assemblies 106 can be exchanged to provide the desired configuration of an electrical connector 106.

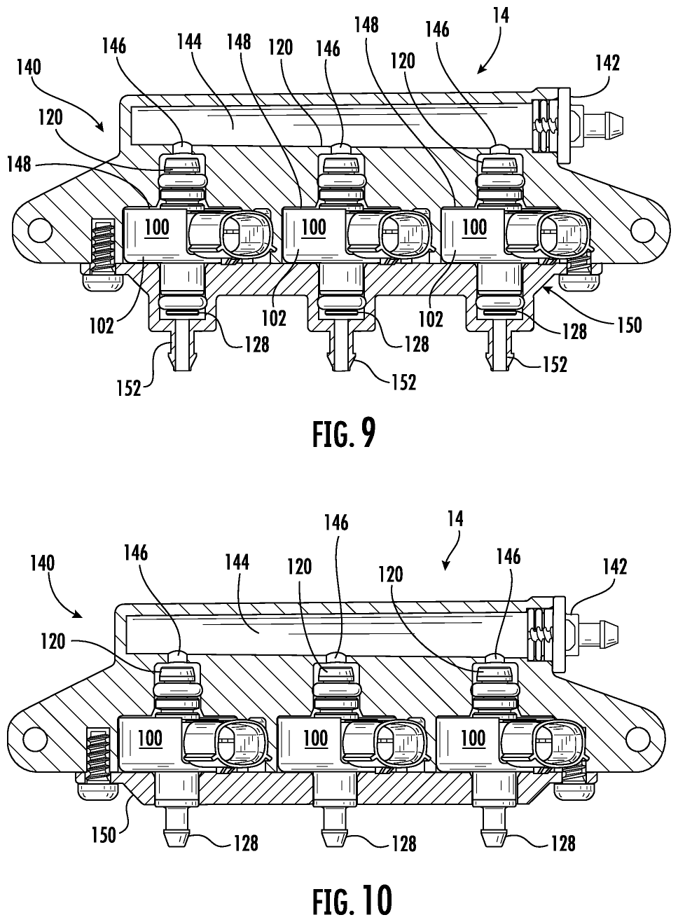

FIGS. 8 and 9 illustrate one embodiment of a distribution manifold 14 according to aspects of the disclosure. The manifold 14 has a main body 140 that supports an inlet 142 and defines a fluid distribution channel 144 that connects the inlet 142 to a plurality of outlets 146. The disclosed manifold main body 140 defines pockets 148 to support a plurality of valves 100. Each pocket 148 includes a bore configured to sealingly engage the inlet 120 of a solenoid 100 and an enlarged area to surround and support the coil assembly 102 of the solenoids 100. The connectors 106 of each valve 100 extend from the manifold 14 for connection to conductors from a control unit 12. In the embodiment of FIGS. 8 and 9 a manifold cap 150 retains the valves 100 in place and defines outlet bores to sealingly engage the outlet 128 of each valve 100. The manifold cap 150 includes outlet fittings 152, which in the embodiment of FIGS. 8 and 9 are industry standard quick connect fittings, but any desired outlet fitting may be used. In the manifold of FIGS. 8 and 9, the outlet fittings 152 are molded as part of the manifold cap 150 and can be changed as desired by employing a different, molded manifold cap 150, without altering the body 140 of the manifold 14.

FIG. 10 illustrates an alternative distribution manifold 14 configured to receive the valve 100 illustrated in FIG. 7. The distribution manifold of FIG. 10 differs from the distribution manifold shown in FIGS. 8 and 9 only with respect to the configuration of the manifold cap 150. In FIG. 10, the manifold cap 150 is configured to allow the integral quick connect fitting on the outlet 128 of the solenoids 100 to extend out of the manifold 14 for connection to wash fluid conduits 24 (shown in FIG. 1).

In operation, the disclosed harsh environment sensor enclosure and cleaning system 10 functions as follows. Vehicle automation and guidance systems 34 in communication with the sensors 48 in the enclosures 16 will determine when sensor cleaning is needed. Signals from the vehicle automation and guidance systems 34 will be sent to the control unit 12 to initiate a wash cycle in one or more sensor enclosures 16. The control unit will start the pump in the wash fluid reservoir 20 to generate fluid pressure in the distribution manifold 14. The control unit 12 will then apply power to one or more of the valves 100 to open the valve 100 and send wash fluid to the respective sensor enclosures 16. Wash fluid will be sprayed from the nozzle 92 into the lens washing space 90 while the valve 100 is open. The control unit 12 will also apply power to the motor 50 in the respective sensor enclosures 16 to rotate the cylindrical lens 80 to move the dirty portion of the lens 80 toward and into the lens washing space 90, where wash fluid assists with removal of contaminants from the surface of the lens 80. The vertical edges 89 of the sensor opening 58 scrape off large debris from the surface of the lens 80, with wipers 88 continuing to remove material from the surface of the lens 80 as it rotates. The wet, clean surface portion of the lens 80 is then rotated out of the lens washing space 90 and past the second set of wipers 88, which remove remaining wash fluid and any remaining debris from the surface of the lens 80. The vehicle automation and guidance systems 34 then determine whether the lens 80 has been cleaned and if not, the wash cycle is repeated until the lens 80 is sufficiently clean that the camera or sensor 48 is operational. The control unit 12 then shuts off the pump in the wash fluid reservoir 20, closes the respective valves 100 and turns off the motor 50 in the respective sensor enclosures 16. The wash cycle may also include operation of a pump to withdraw used wash fluid from the return conduits 30 and allow wash fluid in the lens washing space 90 to drain from the enclosure outlet 94.

Used wash fluid flows out of the lens washing space 90 through outlet 94, facilitated by a pump associated with the recovery filter 18. Used wash fluid may be filtered and returned to the wash fluid reservoir 20 or accumulated in a tank (not shown) for later filtration and re-use or proper disposal. The disclosed sensor enclosures 16 protect the sensor 48 and provide an effective means of cleaning the surface of a lens 80 through which the sensor 48 actively or passively interrogates the surroundings. The disclosed system 10 captures used wash fluid to reduce environmental contamination and may reduce vehicle down time by automating the process of cleaning sensors necessary for vehicle operation.

FIGS. 11 and 12 schematically illustrate an alternative sensor enclosure 16a employing a flat, disc-shaped lens 80a. In this configuration of the sensor enclosure 16a, the sensor opening 58 is semicircular and has an edge in a plane so the opening 58 is compatible with a flat lens 80a. A disc-shaped (flat, circular) lens 80a is arranged to close the sensor opening 58 and protect the sensor 48 within the sensor chamber 56. A motor 50 is connected to the lens 80a by a shaft 54a to rotate the lens 80a when commanded by a control unit such as control unit 12 shown in FIG. 1. The connection between the lens 80a and shaft 54a may be a fastener extending through a hole in the lens 80a or other connection that will ensure rotation of the lens 80a with the shaft 54a. In the enclosure 16a, a washing space 90 is defined on one side of the enclosure 16a and the sensor 48 is arranged on an opposite side of the enclosure 16a. A fluid conduit 24 delivers wash fluid to a washing fluid spray nozzle positioned in the washing space 90, and a wash fluid outlet 94 is arranged to remove used wash fluid from the washing space 90. Other than the differences in the structure of the sensor enclosure 16a, the embodiment of a sensor enclosure 16a and its functionality are the same as that of the sensor enclosure 16 of FIGS. 2-4. As needed or on a pre-determined schedule, the lens 80a is rotated 180° to position the half of the lens 80a that was exposed to the elements within the washing space. Washing fluid is delivered to the washing space 90 to remove material from the outside of the lens 80a and the washing fluid is removed from the washing space 90 through the wash fluid outlet 94. The next time the lens 80a is rotated 180°, the clean portion of the lens 80a is in front of the camera or sensor 48.

It will be observed that the sensor opening in this embodiment is elongated in a vertical direction and narrow in a horizontal direction. It is possible to orient the sensor enclosure perpendicular to the illustrated position, where the sensor opening 58 will be elongated in a horizontal direction and narrow in a vertical direction. The orientation of the sensor enclosure 16a can be chosen to match the range of visibility required by the camera or sensor 48 in the enclosure 16a. For example, rotating the sensor enclosure 16a of FIG. 12 90° counterclockwise, will place the sensor opening 58 at the top of the enclosure 16a and the washing space 90 at the bottom of the enclosure 16a. Such an orientation will provide a horizontally elongated sensor opening 58 and allow gravity to assist in containing washing fluid in the washing space 90. The sensor enclosure 16a can further be oriented in a vertical or horizontal direction that maximizes the effectiveness of the camera or sensor in the enclosure. By selecting sensor and motor components, the sensor enclosure 16a could be made with very little depth to reduce the visibility of the sensor enclosure.

FIGS. 14 and 15 illustrate a third embodiment of a sensor enclosure 16b according to aspects of the disclosure. The sensor enclosure 16b incorporates a hemispherical lens 80b the lower edge of which is received in a lens mounting plate 78 and connected to a motor 50 by motor shaft 54. The hemispherical lens defines a sensor enclosure for a camera or sensor 48. A washing space 90 is defined opposite the sensor enclosure. The washing space 90 is provided with wash fluid by conduit 24 and nozzle 92, with use washing fluid removed via wash fluid outlet 94. A semicircular wiper removes wash fluid and debris from an outside surface of the lens 80b as the lens 80b is rotated by motor 50. The orientation of the camera or sensor 48 within the sensor enclosure 16b may be chosen to make the most effective use of the half-hemispherical window provided by the hemispherical lens 80b. FIG. 14 illustrates the camera or sensor 48 oriented at an acute angle relative to the sides of the sensor enclosure 16b, while FIG. 15 illustrates the camera or sensor oriented parallel to the sides of the sensor enclosure 16b. While the sensor enclosures 16a of FIGS. 11-12 and 16b are illustrated as square or rectangular, the shape of the sensor enclosures is not limited to these shapes, which are used for convenience. The sensor enclosures can be rounded in shape and have a minimum size necessary to serve their function. Similarly, the shape of the lens 80, 80a, 80b can be selected to minimize the size and bulk of the sensor enclosure.

FIG. 13 illustrates an alternative use for the disclosed fluid control valves 100 in a system that uses compressed air. In the system of FIG. 13, a source of compressed air such as a compressor 31 is connected to a manifold 15 with 5 fluid control valves 100 arranged to control flow of compressed air to each of 5 sensors arranged on a vehicle. A controller 12 is connected to selectively open the fluid control valves 100 when instructed by vehicle control and communication systems 34. When a fluid control valve 100 is opened, compressed air is delivered through a nozzle 41 positioned to sweep water or debris from the sensor 48. In this example, the sensor will have its own enclosure on which water or other material can accumulate and impair function of the sensor. A short burst of pressurized air can be used to remove the water or debris and restore sensor functionality.

What is claimed:

1. A sensor enclosure and cleaning system comprising:
a plurality of sensor enclosures, each sensor enclosure including:
a sensor chamber within which a sensor or camera is supported, said sensor or camera receiving information from the environment;
a sensor opening through said sensor enclosure allowing the sensor or camera to receive information from the environment;
a transparent lens spanning said sensor opening, said lens having an outside surface exposed to the environment surrounding said sensor enclosure;
a lens washing space within said sensor enclosure and positioned adjacent a portion of the outside surface of said lens not positioned within said sensor opening, said lens washing space arranged to wash the portion of the outside surface of the lens, said lens washing space substantially sealed off from the environment surrounding the sensor enclosure;
a washing fluid spray nozzle arranged to direct washing fluid at the outside surface of the lens within said lens washing space; and
a washing fluid outlet allowing washing fluid to drain from the lens washing space; and
a motor having a shaft coupled to the lens for rotating the lens to move a portion of the lens from the sensor window to the lens washing space;
a source of washing fluid connected to the washing fluid spray nozzle of each said sensor enclosure;
a washing fluid collection system for collecting washing fluid that drains from the washing fluid outlets of the sensor enclosures;
a control unit connected to each of said sensor enclosures, the source of washing fluid and vehicle systems that receive data from the sensor or camera within each sensor enclosure, the control unit connected to provide power to the motor and to control delivery of washing fluid to the lens washing space of each sensor enclosure;
wherein said control unit responds to a signal from the vehicle systems to clean the cylindrical lens of one or more sensor enclosures, said control unit, in response to said signal, initiating delivery of washing fluid to the lens washing space of said one or more sensor enclosures, and causing the motor to rotate the lens so that the portion of the lens spanning the sensor opening is moved through the lens washing space and a clean portion of the lens is moved to span the sensor opening, used washing fluid draining from the lens washing space for collection.

2. The sensor enclosure and cleaning system of claim 1, wherein the lens is rotationally symmetrical.

3. The sensor enclosure and cleaning system of claim 1, wherein the lens has a shape selected from shapes including a cylinder, a flat circle, a hemisphere, and a convex dome.

4. The sensor enclosure and cleaning system of claim 1, comprising:
washing fluid supply conduits connected to deliver washing fluid to the washing fluid spray nozzle of each sensor enclosure;
a distribution manifold connected to said source of washing fluid to receive washing fluid and connected to the washing fluid conduit of a plurality of said sensor enclosures, said distribution manifold including a valve arranged to fluidly connect or interrupt the source of washing fluid to the washing fluid conduit connected to one of said sensor enclosures in response to a signal from said control unit.

5. The sensor enclosure and cleaning system of claim 1, said washing fluid collection system comprising:
a used washing fluid reservoir for collecting washing fluid that drains from the washing fluid outlets of the sensor enclosures.

6. The sensor enclosure and cleaning system of claim 1, wherein said washing fluid collection system comprising:
a pump arranged to push used washing fluid through a filter; and
fluid conduits connecting the filter to the source of washing fluid,
wherein the used washing fluid is cleaned and returned to a reservoir of washing fluid for reuse in said sensor enclosures.

7. The sensor enclosure and cleaning system of claim 4, wherein the fluid distribution manifold comprises:
a body supporting an inlet and defining a fluid distribution channel connecting the inlet to a plurality of outlets, said body defining a plurality of pockets, each pocket having a bore in fluid communication with one of the plurality of outlets;
a plurality of solenoid operated valves, one solenoid operated valve arranged in each pocket, an inlet of the solenoid operated valve sealingly engaged with said bore, each solenoid operated valve including an outlet axially opposite from the inlet; and
a manifold cap arranged to retain the solenoid operated valves in said pockets, said manifold cap defining outlet openings through which fluid leaves the manifold,
wherein said solenoid operated valves open to fluidly connect the fluid distribution channel to one of the outlet openings in the manifold cap.

8. The sensor enclosure and cleaning system of claim 7, wherein said manifold cap includes an outlet fitting in fluid communication with each of the outlet openings in the manifold cap and said manifold cap defines outlet bores facing said solenoid actuated valves, an outlet of each said solenoid operated valve received in sealed relationship in each of said outlet bores.

9. The sensor enclosure and cleaning system of claim 7, wherein each said solenoid actuated valve includes an integral outlet fitting extending through the outlet openings in the manifold cap.

10. A fluid control valve comprising:
a valve body comprising an inlet, an outlet, and a tubular body extending between said inlet and said outlet,
said inlet constructed of magnetic metal and defining an axial fluid flow passage, said inlet including an integral inlet coupling at an inlet first end for connecting the valve to a fluid conduit, an inlet second end connected to the tubular body and facing said armature;
said outlet defining an axial flow passage and including an integral outlet coupling at an outlet second end for connecting to a fluid conduit, said outlet first end facing said inlet second end, said outlet including a valve seat surrounding said axial flow passage;
said tubular body constructed of non-magnetic metal, said tubular body extending from a first end welded to the inlet second end to a second end welded to said outlet first end;
an armature arranged within a space surrounded by said tubular body and axially between said inlet second end and said outlet first end, said armature having a stop face adjacent said inlet second end and supporting a valve member facing said valve seat, said armature biased away from said inlet second end and into a closed position with said valve member engaged with said valve seat by an armature return spring, said armature defining a fluid flow path from the stop face to an area surrounding the valve member and adjacent the valve seat; and
a solenoid assembly including a coil surrounding the tubular body and an axial gap between the inlet second end and the armature stop face, said solenoid assembly comprising magnetic components completing a flux path for magnetic flux generated by the coil when power is applied to the coil, said flux path extending through the inlet second end and the armature,
wherein the inlet forms a magnetic pole of a solenoid and includes the inlet coupling, and the outlet defines the valve seat and includes the outlet coupling.

11. The fluid control valve of claim 10, comprising a non-metallic shock absorbing element between the inlet second end and the armature stop face, said shock absorbing element preventing direct contact between the armature stop face and the inlet second end.

12. The fluid control valve of claim 11, wherein said shock absorbing element is a cylinder of plastic surrounding the inlet axial fluid flow passage, an end of the cylinder projecting beyond the inlet second end.

13. The fluid control valve of claim 11, wherein the shock absorbing element is constructed of PEEK.

14. The fluid control valve of claim 11, wherein the end of the cylinder projects at least 0.5 mm beyond the inlet second end.

15. A method of assembling the fluid control valve of claim 10, comprising:
welding the tubular body to the first end of the outlet;
placing the armature and connected valve member into a space surrounded by the tubular body with the valve member against the valve seat;
arranging the armature return spring in a recess defined in the stop face of the armature;
inserting the inlet second end into the tubular body so that the armature return spring is received in a recess defined in the inlet second end;
advancing the inlet second end into the tubular body until the axial gap between the armature stop face and the inlet second end is a predetermined axial distance; and
welding the inlet second end to the tubular body.
